(19) United States
(12) Patent Application Publication
(10) Pub. No.: US 2022/0281669 A1
(43) Pub. Date: Sep. 8, 2022

(54) PACKAGING SYSTEM AND METHOD FOR PRECISELY PREPARING FRESH FOOD ITEMS SUCH AS TAHINI

(71) Applicants: Alon Ben David, Los Angeles, CA (US); Gilad Erlich, Los Angeles, CA (US)

(72) Inventors: Alon Ben David, Los Angeles, CA (US); Gilad Erlich, Los Angeles, CA (US)

(21) Appl. No.: 17/192,878

(22) Filed: Mar. 4, 2021

(51) Int. Cl. B65D 77/20; B65D 25/20; B65D 43/02; B65D 51/28; B65D 51/18; A23L 27/60; A23L 23/00; A23L 25/00; A23L 27/12

(52) U.S. Cl. CPC B65D 77/20; B65D 25/20; B65D 43/0202; B65D 51/28; B65D 51/18; A23L 27/60; A23L 23/00; A23L 25/30; A23L 27/13; B65D 2251/0018; B65D 2251/0093; B65D 2543/00092; A23V 2002/00

(57) ABSTRACT

The present invention discloses a preferably single-serve and disposable container and lid packaging system for facilitating the preparation of a fresh food item to a desired consistency. The container contains a pre-measured amount of a main food item to be prepared, and its side wall has at least one visual indicator indicating an amount of liquid to add to the container and to be mixed with the main food item. The invention is particularly useful for making a single-serve portion of ready-to-eat tahini by adding a lemon juice mix contained in the lid, adding water to a visual fill-to line in the container containing raw tahini (or the lid), and then thoroughly mixing the mixture.

### RELATED APPLICATIONS

None.

### TECHNICAL FIELD

The present invention relates generally to the field of food containers, and in particular to containers for food items that require preparation with the addition of and mixing therewith a precise amount of liquid before consumption.

### BACKGROUND

Single-serve food items that are packaged in disposable containers are well known. Many such items are sold with a main food item contained in a sealed container and a complementary food item contained in a separately sealed compartment, often in the cover or lid of the container. When a user is ready to eat the food, she may separate the lid from the container, break or peal open the seals on both, pour the contents of the lid into the container and mix them together. A well-known example of such a product and packaging system is the single-serve yogurt packaging found in the dairy section of grocery stores, typically directed to kids, wherein the complementary food item, such as granola or a cookie crumb mix, is stored in the sealed lid, for conveniently adding to the yogurt in the container immediately before eating it.

Other containers are directed to the challenges of adding to them measured amounts of one or more food or liquid items, often for mixing them together. Application publication no. US2020/0299035 titled “Measurable Disposable Container and Lid” to Frizzell offers a potential solution. This disclosure shows a food and liquid storage container having a cylindrical container body portion and a lid. The interior surface of the body of the storage container contains an embossed portion line and a portion indicator. This system is directed to the health-conscious consumer who is tracking the total calories and macronutrients of each food product, product ingredient and/or meal that an individual consumes in a given day. Thus, these lines help an individual measure the predetermined amount of food to add, making the monitoring of total calories consumed much easier for an individual.

There is a certain category of food items that requires a good deal of relatively exacting and cumbersome preparation steps before consumption, and thus does not readily lend itself to simple mass-produced, single-serve, ready-to-eat applications, as in the case of the yogurt-plus-complementary-food packages. This food group is typically sold to consumers in an unprepared or “pure” state and often requires the addition of a relatively precise amount of liquid, such as water, and/or flavoring, along with a good deal of mixing before making a fresh, comestible end product. Thus, these food items are often sold in larger, multi-serving quantities, and the user must go through a number of precise preparatory steps—i.e., a recipe—before enjoying one or more servings. These steps include measuring out a precise amount of base, or “pure” food and placing or pouring it into a mixing bowl, measuring out a precise amount of liquid admixture, such as water and optionally other liquid flavoring, and pouring that into the same bowl, adding spices, and then mixing all the ingredients together to make the finished, fresh, ready-to-eat end product. Besides being time intensive, this effort also results in dirtied measuring utensils and the mixing bowl or bowls that require washing. Because of these drawbacks, many people choose to not even bother preparing these fresh food items, especially when they are on-the-go and/or when the desired amount is a small, single serve serving.

One increasingly popular food item worldwide that falls in this category and suffers from the preparation preciseness and effort problems is tahini. Tahini (also called tahina) is crushed and pureed sesame seed that in its pure state—which may also hereinafter be referred to as “raw tahini” (although not necessarily in the sense that the fresh seed is uncooked)—has some interesting properties. Pure tahini has a relatively long shelf life and is typically sold in larger sized, multi-serving containers. It has many uses as an ingredient in a recipe. However, although pure tahini has a delicious flavor, it is not typically consumed as is, right from the bottle or container it is sold in. Rather, pure tahini is typically mixed with a good amount of liquid, usually water, before being consumed. The main reason is that raw tahini absorbs a good amount of the first liquid that is added to and mixed with it, becoming more viscous (thicker) than the pure raw product itself. Only after crossing a tipping point of additional water added to the mixture will it start to become less viscous and suitable for direct eating. This property makes this process what some people call “the art of making tahini.” Also, once prepared with the “right” amount of water and often a citrus (lemon) juice flavoring, the fresh, ready-to-eat mixture (without adding preservatives) lasts in a refrigerator for only a few days. Thus, it is not practical or economical to prepare and sell fresh, ready-to-eat tahini in volume, at least without undesirable added preservatives.

Moreover, there are many “recipes” for turning pure tahini into a fresh, delicious, ready-to-eat tahini product, as tahini can serve myriad uses that are largely a function of its desired final thickness state (and spicing preferences). For example, tahini can be made into a spread, a dip, a sauce or a salad dressing. However, all conventional ready-to-eat tahini recipes follow this basic outline: (a) the pre-mix stage—ensure that the natural sesame oil (or other added oil) that tends to separate and rise to top of the raw tahini sitting in its purchased container is well-mixed with the rest of the sesame product in the container; (b) remove from the container a desired, measured amount of the “raw” product and place it into a mixing bowl; (c) add to it a desired amount of flavoring, such as a citrus (lemon) juice, garlic, and spices, (d) add to that mixture a prescribed amount of water relative to the amount of raw product in the bowl, where the amount would differ depending on the desired thickness (use) of the end product; and finally (e) thoroughly mix all the ingredients together in the bowl to create a smooth, creamy end product. Traditionally, the mixing step is often done using mortar and pestle grind and mix process, but more commonly this is done using any rounded bowl and mixing utensil, such as a spoon, fork or blender other similar tool.

Accordingly, it would be desirable to have a solution for this group of food products, including pure tahini, that requires preparation with precise amounts of added liquids, that overcomes the challenges in the prior art, and that makes it easy and even foolproof to repeatedly prepare a “perfect,” fresh, ready-to-eat end product at the time of eating and at a desired consistency. It would be further desirable for such a solution to be made available for long-shelf life, single serve uses, and preferably using disposable container materials, and that could be stored and sold in quantity at any grocery store or supermarket or shipped anywhere.

### SUMMARY

The present invention meets these needs by disclosing food packaging system for facilitating the preparation of a fresh food item to a desired consistency. The system preferably includes a container and a mating lid. The container may have a side wall and a bottom that define inner and outer surfaces and an open top. The container preferably contains therein a pre-measured amount of a main food item to be prepared. The lid has an inner end that removably covers the container open top. In a preferred embodiment, the container side wall includes a visual indicator indicating an amount of liquid to add to the container and to be mixed with the main food item.

In preferred embodiments, the container and lid are disposable, and the pre-measured amount of the main food item is a single serving. In some embodiments, the main food item is less than 5 fluid ounces of raw tahini.

The system of the invention may further include a base connected to the outer surface of the container for placing the container on a substantially flat surface. Moreover, the inner surface of the bottom of the container may be designed to have no corners in order to facilitate a complete mixing of the liquid and the main food item.

In yet other embodiments, the container further includes a rim disposed around the open top having a lip that extends inwardly over the open top. This is designed to retard the splashing out of the container of the main food item and liquid during mixing.

In more detailed embodiments of the present invention, the lid defines an inner space which contains a liquid flavoring, such as a lemon juice mix, to be deposited into the container together with the measured liquid. The packaging system of the invention is some embodiments is useful for long shelf-life applications. Thus, the container and lid may each be sealed with a removable film for removing before preparation of the fresh food item.

In other detailed embodiments, the container side wall may have three visual “fill-to” indicators, each indicating a different amount of liquid to add to the container and to be mixed with the main food item, corresponding to a different desired consistency of the fresh food product. These three visual indicators may also include words indicating the different desired consistency of the fresh food product. The invention is particularly useful when the main food item in the container is raw tahini and the liquid to add to the container is water.

The present invention also discloses a packaging system for facilitating the preparation of a fresh food item to a desired consistency. This system includes a container having a side wall and a bottom defining inner and outer surfaces, and an open top, the container containing therein a pre-measured amount of a main food item to be prepared; and a lid having an inner end that removably mates with the container open end, the lid defining an inner space having an inner wall. In this alternative embodiment, the inner wall of the lid includes a visual indicator indicating a measured amount of liquid to add to the inner space of the lid for subsequently pouring into the container.

Optionally, the system may further include a disposable mixing utensil, such as a plastic spoon packaged with the container and lid for mixing the pre-measured amount of the main food item and measured amount of liquid in the container.

The present invention also discloses a container for adding a precise amount of a liquid admixture when the container contains a preset amount of a main food item to be mixed with the liquid. This may result in a ready-to-eat food product. This container may include a side wall, a bottom defining inner and outer surfaces, and an open top. The side wall, in this case, includes at least one visual measurement line indicating the amount of liquid admixture to add to the container when the container contains the preset amount of the main food. In an alternative option to this container, the side wall may include three substantially parallel, horizontal visual measurement lines, each indicating an amount of liquid admixture to add to the container when it contains the preset amount of the main food, depending on the desired consistency of the ready-to-eat food product. The side wall may further include at least one different word associated with each of three horizontal visual measurement lines, each at least one word indicating a different ready-to-eat food product. In a preferred use case of this embodiment, the main food product is raw tahini, the liquid admixture is water, and the words disposed on the side wall are “spread” “dip” and “salad dressing.”

A method for making a fresh ready-to-eat tahini serving using a container that contains a preset amount of raw tahini and a container lid that contains a preset volume of liquid flavoring, is also disclosed. This method includes the steps of pouring the volume of liquid flavoring into the container; adding water to the container in an amount that causes the combination of the raw tahini, liquid flavoring and added water to reach a visual measurement line disposed on the container; and mixing the combination of the amount of raw tahini, volume of liquid flavoring and added water. In this method, the liquid flavoring in the lid may be a lemon juice mix. Moreover, the container may include three visual measurement line. In such case, the step of adding water comprises adding water in an amount that causes the combination to reach any of the three measurement lines, depending on the desired end consistency of the fresh, ready to eat tahini serving

It is to be understood that the invention is not limited in its application to the details of construction and the arrangement of components described hereinafter and illustrated in the drawings. Those skilled in the art will recognize that various modifications can be made without departing from the scope of the invention.

### BRIEF DESCRIPTION OF THE DRAWINGS

Further advantages of the present invention may become apparent to those skilled in the art with the benefit of the following detailed description of the preferred embodiments and upon reference to the accompanying drawings in which:

FIG. 1 is a diagrammatic perspective view of a container bowl showing “fill-to” measurement lines in accordance with one non-limiting embodiment of the present invention;

FIG. 2 is a diagrammatic perspective view of an alternative embodiment of the present invention showing a container body and lid system for making a ready-to-eat product.

FIG. 3 is a perspective view of the system as shown in FIG. 2 with the container and lid separated and with the insides of the container and lid having pure tahini and liquid flavoring products sealed in each, respectively;

FIG. 4 is a diagrammatic top view of the lid device shown in FIGS. 2 and 3;

FIG. 5 is an alternative embodiment of a container body having functional words alongside “fill-to” lines in accordance with another non-limiting embodiment of the present invention; and

FIG. 6 is an alternative embodiment of the present invention showing a lid with “fill-to” lines.

### DETAILED DESCRIPTION OF THE PREFERRED EMBODIMENTS

Referring now to the drawings, like reference numerals designate identical or corresponding features throughout the several views.

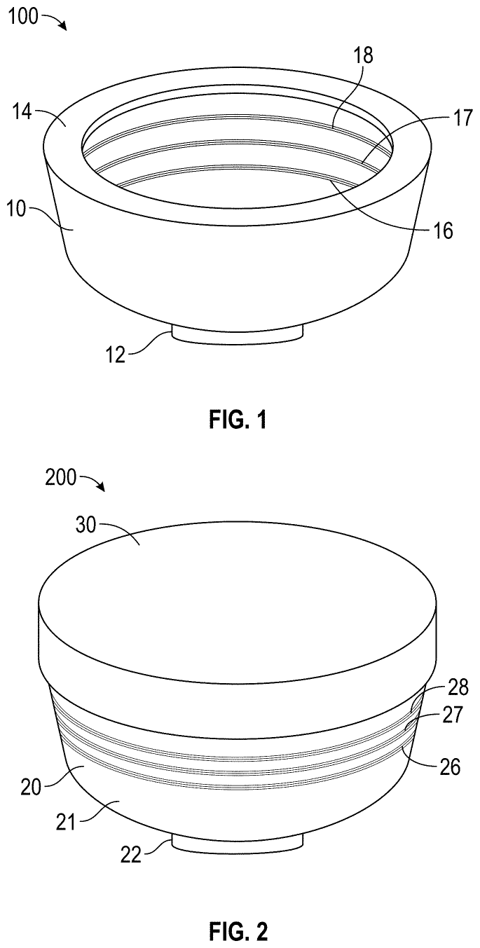

In one preferred embodiment, a container used in a food packaging system according to the present invention is shown in FIG. 1. Container 100, which may be disposable, comprises bowl body 10, base 12, and lip 14, and preferably serves as a vessel within which a raw or base food item to be prepared, such as raw tahini, is placed and stored for later preparation. Preferably, a predetermined amount of the base food item to be prepared, such as relatively long shelf-life raw tahini, is deposited inside the bowl body 10 which is then sealed at its top during manufacturing. The inside wall of bowl body 10 may preferably be cylindrical and its bottom may be rounded, preferably without hard corners. Base 12 is shown as a small flat platform disposed in the middle of the bottom of the body 10, but it should be understood that other base shapes are within the scope of the present invention, such as legs or a wall portion that extends downward from the outer bowl. The purpose of base 12 is to enable the container to rest on a flat, preferably level surface. Lip 14 of the container is designed to serve as a backsplash of sorts to help prevent the food items being mixed inside bowl body 10 from splashing out of container 100 during vigorous mixing.

An important aspect of the system of the present invention is the “fill-to” measuring line feature that serves as a visual marker for the user preparing the food item to know how much liquid, such as water, to place in bowl body 10 (that contains the main food item) before the mixing step. This obviates the need of the user to use a separate liquid measuring instrument, such as a measuring cup, to fill with a precise amount of water required to mix with the food item in the container and then pour into container. Accordingly, in the preferred embodiment shown in FIG. 1, container 100 includes three parallel measuring lines, 16, 17, and 18 disposed around inner circumference of bowl body 10. Each of these lines corresponds to a slightly different “thickness recipe”, such that filling container 100 that already has in it a predetermined amount of pure food product, such as “raw” tahini, with, say, water to line 16 will result—after mixing—in final, ready-to-eat product that has a dense consistency (high viscosity), such as a tahini spread. Filling container 100 with water up to line 17 will result in a less thick final product (medium viscosity), such as a tahini dip, and filling it to line 18 will create the looser consistency end product (low viscosity), such as a tahini salad dressing.

Embodiments of the present invention are particularly useful for the easy and precise preparation of a single portion or smaller portions of fresh, ready-to-eat, tahini. As noted above, tahini is a healthy natural food item, originating in the Middle East that has in recent years become very popular worldwide. Raw tahini, has a long shelf life but conventionally needs a good deal of preparation to make it “just right” for ideal consumption—that is, by thoroughly mixing the raw product with the proper amount of flavoring, most commonly lemon juice and spices, and a precise amount of water to achieve the desired consistency. Until the present invention, the inventors of the present invention found that it was simply impractical or too burdensome for consumers who would like to eat fresh ready-to-eat tahini to follow a recipe, and do the work needed to prepare a single serving.

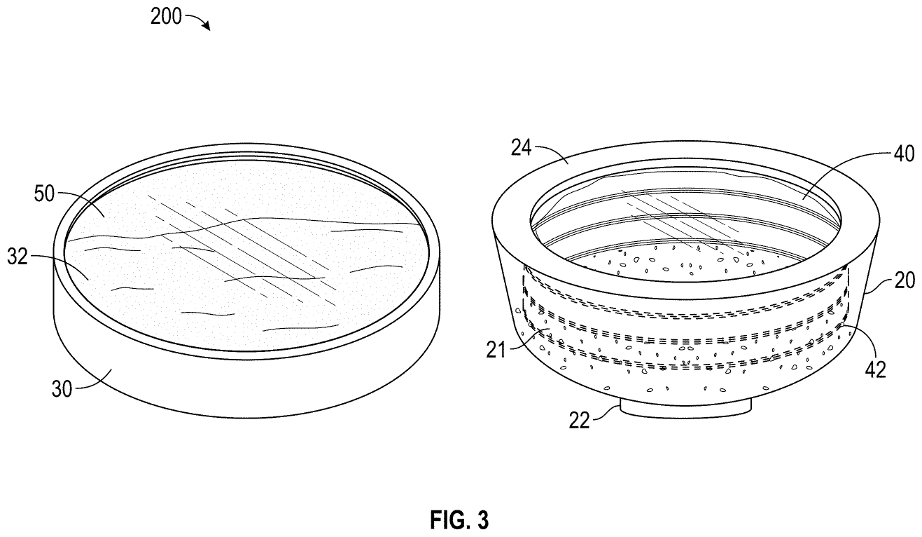

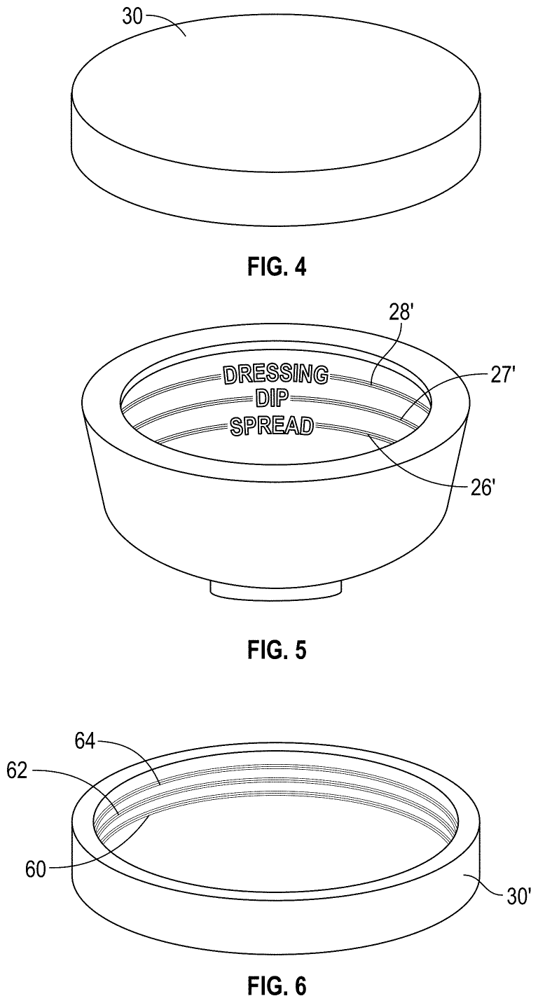

Thus, in one particular embodiment of the present invention, a single-serve, disposable, tahini packaging system 200 as might be found on a grocery store shelf is shown in FIGS. 2 and 3. As will be explained, a purchaser of this system 200 can easily prepare a fresh, “perfect every time”, single serving of ready-to-eat tahini in a disposable package. The system has a predetermined amount of raw tahini (see FIG. 3) contained in disposable container 20 having bowl body 21 and base 22, and a lemon juice mix 32 contained in disposable lid 30. As seen, body 21 also includes visible, “fill-to” lines 26, 27 and 28—in this embodiment, visible both on the inside and outside of bowl body 21—for visually directing the user to add water to container 20 up to any one of the lines corresponding to a desired consistency of the end product to be consumed. Thus, FIG. 3 shows a view of the system of FIG. 2 with lid 30 off container 20, and bowl body 21 shown in a see-through view. As seen, container 20 preferably contains a predetermined amount of long shelf-life raw tahini 42 and is maintained inside body 21, preferably with a peel-away seal 40 sealing the open top of body 20. Similarly, a predetermined amount of lemon juice mix 32, which may also be prepared with various spices and flavorings, is stored in the volume of space created by the underside of lid 30 and is sealed therein preferably with a peel-away film closing the opening of lid 30. In this way, this single-use packaging system may be manufactured in large volumes, shipped to stores and stored on the shelf for long periods of time.

Using the system of the present invention, preferably all of the key ingredients needed to make fresh tahini, except the water, are stored, and can be sold in a grocery store, in a single, long-shelf-life unit 200. This enables an inventive method of the present invention for easily preparing a fresh food item requiring a measured amount of liquid. Thus, when the user is ready to prepare the mix for consumption, she simply snaps off lid 30 and peels film 40 off bowl body 20 exposing the raw tahini. The user then may peel film 50 off away from lid 30 and pour the lemon juice mix 32 stored therein into bowl body 21. Now, the user may add water to bowl body 21 until the volume of raw tahini 42, lemon juice mix 32 and water reaches a desired one of the measuring lines 26, 27, or 28, corresponding to high viscosity (e.g., a spread), medium viscosity (e.g., a dip) or low viscosity (e.g., a salad dressing) tahini end product, respectively. Preferably, the user will add the water when base 22 is resting on a flat, horizontal surface so that the raw contents in and fill-to measuring lines of body 21 are horizontal for accurate measurement. Finally, using a mixing utensil such as a spoon or fork, etc., the user can vigorously mix all ingredients together until the desired smoothness of the combined items are achieved. Delicious, fresh product is now ready to eat.

In an alternative embodiment of FIGS. 2 and 3 shown in FIG. 5, the container may include measuring lines 26′, 27′ and 28′ that include descriptive words indicating the type of final product to be created by adding water to the respective line. Thus, the user will know that adding water to the lowest line 26′ will result in a tahini spread (the thickest use of tahini), adding water to line 27′ will result in tahini dip, and adding water up to fill-to line 28′ will create a tahini dressing, the least viscous recipe.

Many alternative embodiments are contemplated by the present invention. For example, only one “fill-to” line may be provided on the mixing bowl. Also, instructions for making ready to eat product may be printed on the container or lid. Moreover, in disposable single use embodiments of the system of the present invention, a disposable mixing utensil, such as a paper or plastic spoon may be packaged with the container/lid combination.

In yet another alternative embodiment shown in FIG. 6, in place of (or in addition to) container bowl body 21 in FIGS. 2 and 3 having one or more “fill to” lines, measuring lines 60, 62, 64 (or one line) may be included on the inside of lid 30′. In one implementation of this alternative, after a peel away film is removed from lid 30′ and all the lemon juice mix contained therein is emptied into its mating container containing the raw tahini (similar to the steps described in connection with FIGS. 2 and 3), the now empty lid 30′ may be refilled with water in an amount up to one of the fill-to measurement lines, and then emptied into the container containing the pure food item and liquid flavoring, followed by a vigorous mixing of all ingredients as explained above. This alternative offers the option of simply measuring the desired amount of water to be used by liquid weight rather than liquid volume, as would be done in the prior embodiments, where water is added directly to bowl body 21 up to one of the lines included in the body wall. Moreover, creating the final tahini product having a desired consistency using this embodiment may be considered more forgiving than having the lines in the container, because now a user can correct a “wrong” amount of water filled into lid 30′ before committing to add it to the raw tahini-lemon juice mix mixture in the container, for example, by spilling out a bit of water from lid 30′ that the user inadvertently filled past the desired fill-to measuring line.

While embodiments of the invention have been illustrated and described, it is not intended that these embodiments illustrate and describe all possible forms of the invention. Various changes, modifications, and alterations in the teachings of the present invention may be contemplated by those skilled in the art without departing from the intended spirit and scope thereof. It is intended that the present invention encompass such changes and modifications.

1: A packaging system for facilitating the preparation of a fresh food item to a desired consistency, comprising:
a. a container having a side wall and a bottom that define inner and outer surfaces and an open top, the container containing therein a pre-measured amount of a main food item to be prepared; and
b. a lid having an inner end that removably covers the container open top;
wherein the container side wall includes a visual indicator indicating an amount of liquid to add to the container and to be mixed with the main food item.

2: The system of claim 1, wherein the container and lid are disposable.

3: The system of claim 2, wherein the pre-measured amount of the main food item is a single serving.

4: The system of claim 3, where the main food item is less than 5 fluid ounces of raw tahini.

5: The system of claim 1, further including a base connected to the outer surface of the container for placing the container on a substantially flat surface, and wherein the inner surface of the bottom of the container has no corners for facilitating a complete mixing of the liquid and the main food item.

6: The system of claim 1, wherein container further includes a rim disposed around the open top having a lip that extends inwardly over the open top for retarding the splashing out of the container of the main food item and liquid during mixing.

7: The system of claim 1, wherein the lid defines an inner space that contains a liquid flavoring to be deposited into the container.

8: The system of claim 5, wherein each of the container and lid are sealed with a removable film for removable before preparation of the fresh food item.

9: The system of claim 1, wherein the container side wall contains three visual fill-to indicators, each indicating a different amount of liquid to add to the container and to be mixed with the main food item, corresponding to a different desired consistency of the fresh food product.

10: The system of claim 9, wherein each of the three visual indicators include words indicating the different desired consistency of the fresh food product.

11: The system of claim 1, wherein the main food item in the container is raw tahini and the liquid to add to the container is water.

12: A packaging system for facilitating the preparation of a fresh food item to a desired consistency, comprising:
a. a container having a side wall and a bottom defining inner and outer surfaces, and an open top, the container containing therein a pre-measured amount of a main food item to be prepared; and
b. a lid having an inner end that removably mates with the container open end, the lid defining an inner space having an inner wall;
wherein the inner wall of the lid includes a visual indicator indicating a measured amount of liquid to add to the inner space of the lid for subsequently pouring into the container.

13: The packaging system of claim 12, wherein the container and lid are disposable, and further including a disposable mixing utensil packaged with the container and lid for mixing the pre-measured amount of the main food item and measured amount of liquid in the container.

14: A container for adding a precise amount of a liquid admixture, with the container designed to contain a preset amount of a main food item to be mixed with the liquid to result in a ready-to-eat food product, comprising:
a. a side wall;
b. a bottom defining inner and outer surfaces; and
c. an open top,
wherein the side wall includes at least one visual measurement line indicating the amount of liquid admixture to add to the container when the container contains the preset amount of the main food.

15: The container of claim 14, wherein the side wall includes three substantially parallel, horizontal visual measurement lines, each indicating an amount of liquid admixture to add to the container when it contains the preset amount of the main food, depending on the desired consistency of the ready-to-eat food product.

16: The container of claim 15, wherein the side wall further includes at least one different word associated with each of three horizontal visual measurement lines, each at least one word indicating a different ready-to-eat food product.

17: The container of claim 16, wherein the main food product is raw tahini, the liquid admixture is water, and the words disposed on the side wall are “spread” “dip” and “salad dressing”.

18: A method of making a fresh ready-to-eat tahini serving using a container that contains a preset amount of raw tahini and a container lid that contains a preset volume of liquid flavoring, comprising:
(a) pouring the volume of liquid flavoring into the container;
(b) adding water to the container in an amount that causes the combination of the raw tahini, liquid flavoring and added water to reach a visual measurement line disposed on the container; and
(c) mixing the combination of the amount of raw tahini, volume of liquid flavoring and added water.

19: The method of claim 18, wherein the liquid flavoring in the lid is a lemon juice mix.

20: The method of claim 18, wherein the container includes three visual measurement lines, and the step of adding water comprises adding water in an amount that causes the combination to reach any of the three measurement lines, depending on the desired end consistency of the fresh, ready to eat tahini serving.
